(19) United States
(12) Patent Application Publication
(10) Pub. No.: US 2013/0291092 A1
(43) Pub. Date: Oct. 31, 2013

(54) Security Method and Apparatus Having Digital and Analog Components

(71) Applicant: Christopher L. Andreadis, Belle Mead, NJ (US)

(72) Inventor: Christopher L. Andreadis, Belle Mead, NJ (US)

(21) Appl. No.: 13/455,443

(22) Filed: Apr. 25, 2012

(51) Int. Cl. G06F 21/00

(52) U.S. Cl. 726/18

(57) ABSTRACT

A method and apparatus for creating and implementing a security protocol. The security protocol preferably includes a dichotomous, or two-part, code. The first part includes a digital component such as an alphanumeric sequence while the second part includes an analog component such as that encountered in any physical attribute. The analog component may also be modeled as a number of different information prototypes, such as a span of time or a musical tone. The resultant combination may be embodied, for example, by a dichotomous password that is used to gain clearance to secure assets and features the ability to “profile” the user requesting secure access in real-time. The password may include a string of characters in which part of the password constitutes entry of each character over varied intervals of time.

### BACKGROUND OF THE INVENTION

1. Field of the Invention

The invention is directed to the field of security methods and apparatus and, more particularly, to security methods and apparatus employing a password which includes both digital and analog components.

2. Description of the Related Art

Security is an ever-present concern in our society. Everyone has something of value, and want to keep safe. However, there are always people who want to take someone's valuable something, whether that something is money, tangible property, information or something else. Security protocols have been developed to protect valuable property, and these protocols have become increasingly sophisticated. While security protocols improve, however, so do the methods for attacking those protocols.

A common security protocol is the use of a password to open a secure location, such as a locked room, a computer, or other location, whether physical or virtual, or gain access to an asset, tangible or intangible, such as an automobile or bank account. For ease of reference, the term “location” will be used herein to mean any type of location, whether physical or virtual, and also to mean an asset, whether tangible or intangible, since the location (including asset) for which access is restricted is irrelevant to the practice of the invention.

Passwords usually consist of a predetermined alphanumeric sequence assigned to one or more users. An authorized user, possessing the password, enters it by way of an input device, such as a keypad at a locked door, and thereby gains access to the secure location.

This system, while providing satisfactory security in most applications, has some drawbacks. For example, the simplicity of the password allows the authorized user to give it to an unauthorized user, either innocently, such as to a colleague who locked himself out, or purposely, such as to janitorial staff to clean up a spill within the secure location, or for more nefarious purposes. Therefore, it would be helpful if there were an improved security protocol that is not so simple to pass on to others.

Another drawback of many known security protocols is that passwords are often selectable by the authorized user. Most users choose passwords that are easy to remember, which makes them easy to steal, or infer from information known about the user, such as a birthday or anniversary. Others may write down the passwords so they do not have to remember them, also making them easy to steal.

Some existing security protocols encompass a means to generate fixed random sequences as unique digital passwords assigned specifically and immutably to a single authorized user. However, even such protocols are vulnerable to the human element, for example where an individual gives the generator chip to an unauthorized user. There is thus a need in the art for an improved security protocol that is less vulnerable to known security threats.

### BRIEF SUMMARY OF THE INVENTION

It is therefore an object of the invention to provide an improved method and apparatus for securing locations and systems against unauthorized access.

It is another object of the invention to provide a dichotomous password containing both a digital component, such as an alphanumeric code, and an analog component, such as the duration of each code element in a sequence, to establish a security protocol that is difficult to transfer.

It is a still further object of the invention to provide a security protocol which includes a password that cannot be simply conveyed to an unauthorized user, and would require the authorized user to learn the security protocol and not simply write down a password.

It is a still further object of the invention to provide a novel method for generating the digital component of the security protocol, preferably at the same time as generating the analog component thereof.

In accordance with these and other objects of the invention, there is provided a method and apparatus for implementing a security protocol having both digital and analog components. In a preferred embodiment of the invention, the method includes generating both components at the same time, from the same source, such as background noise, and then associating the two, such as by storage in a memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to illustrate in concept the structures and procedures described herein.

### BRIEF DESCRIPTION OF THE DRAWINGS

The drawings include the following figures, in which like reference numerals refer to like elements and/or steps:

FIG. 1 is a block diagram of an embodiment of the inventive system and method;

FIG. 2 is a normal binomial probability distribution where Px=(1−Px)=0.5;

FIG. 3 is an oscilloscope display showing binary quantization of avalanche noise;

FIG. 4 is an amplitude data distribution of real Gaussian noise;

FIG. 5 is an amplitude data distribution of synthesized Gaussian noise;

FIG. 6 is a sampling technique used in a True Random Number Generator;

FIG. 7 is the NRCL digitized noise sampling CLOCK;

FIG. 8 illustrates the granularity of a digital period measurement;

FIG. 9 is the SNAP tonal series interval with a 250 mS lead-in;

FIG. 10 are the key slot subdivisions within the tonal series;

FIG. 11 illustrates a key press (actuation) within a continuous time interval;

FIG. 12 is a flowchart of one representative implementation of the inventive methodology, system and apparatus;

FIG. 13 is a flowchart of one representative training method that may be implemented according to the invention methodology, system and apparatus; and

FIG. 14 is a flowchart of a representative vetting method that may be employed using the inventive method, system and apparatus.

### DETAILED DESCRIPTION OF THE PRESENTLY PREFERRED EMBODIMENT

The following detailed description of the presently preferred embodiment will describe the inventive Non Repeatable Code Lifetime (NRCL) method that encompasses the device. The NRCL generator comprises a method and an apparatus for generating a sequence having both digital and analog components. Both components are generated randomly and combined to create a single security protocol that is more resilient than those heretofore known. Preferably, both components are generated simultaneously, and then associated with one another, such as in a memory.

The Non-Repeatable Code Lifetime (NRCL) generator is a machine manifest as an electronic device encompassing a well-defined process that generates a code, i.e., a number or machine state, accompanied by the code's measured duration or lifetime at the output.

Both symbolic and non-symbolic information is continually generated at the NRCL output as derived from its internal noise sources, also called its statistical entropy sources. A notable feature of the NRCL device is the augmentation, or binding, of these two classes of information in the form of a bound data type. In other words, we have an augmented symbolic/non-symbolic information class in every rendering of data presented at the NRCL output. The bound data type is indivisible both in principle and, consequently, in practice. Note that all information class references in this document are deemed valid within the scope and context of the inventive method. They are necessary and sufficient for explaining basic design features of the device without regard to correctness of, or possible controversy over, the classification terms themselves.

Examples of symbolic information are letters, numbers, the word “red”, wind velocity data, tax ID information, map coordinates, etc. and generally all abstract entities that are categorically discrete and discontinuous. Examples of non-symbolic information are a musical tone, the feel of silk, the color red, a worker bee's “dance”, the span light travels in a second, how long the sound of thunder takes to dissipate, etc., and generally all physical attributes that exist without requisite quantification and are unequivocally non-discrete and continuous. We emphasize the fact that every instance of either information class can be represented by its antithesis through a symmetric mathematical process such as analog-to-digital/digital-to-analog conversion (ADC/DAC).

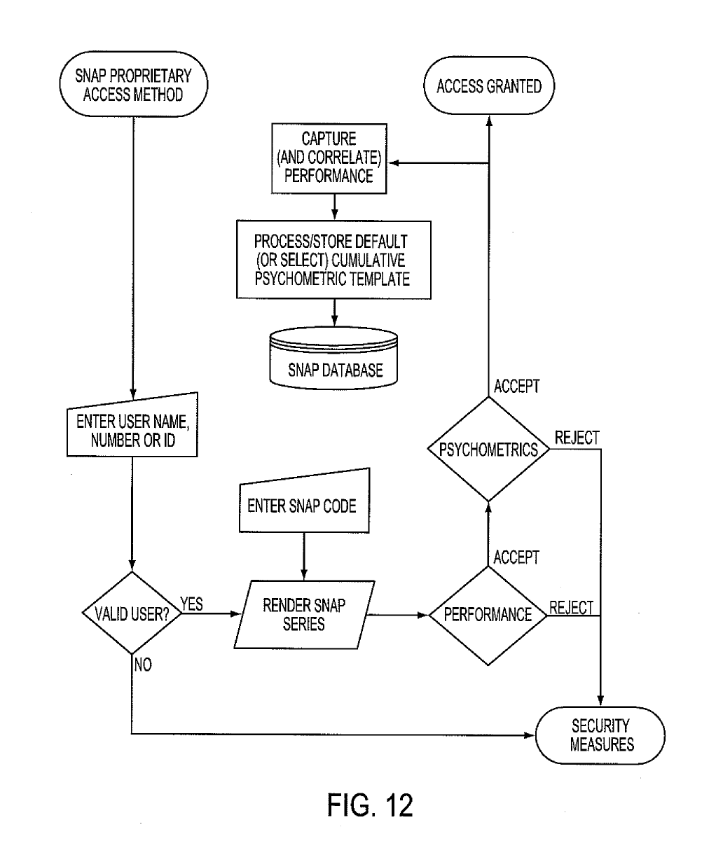

A comprehensive application of the inventive method is presented below and termed the Symbolic/Non-symbolic Access Protocol (SNAP), which establishes a novel type of security protocol illustrated in FIG. 12.

In one embodiment according to the SNAP method, each authorized user has a numeric code, analogous to a PIN, linked to a series of sensory stimuli that are capable of affecting the sense of hearing, sight, or potentially any sensory input, and figuratively referred to as a “sensory event”. It will also be appreciated that the sensory stimuli of a single sensory event may, for example, be any combination, or overlay, of sensory stimuli. For ease of discussion, the sensory stimuli referred to herein shall be characterized as musical tones and the sensory event as a musical sequence, but it will be appreciated that the same procedures apply regardless of the nature of the stimuli.

After a user establishes his or her identity at, for example, an access point keypad, he or she must then enter the SNAP code with each key being pressed at precisely the right moment in coincidence with certain tones of the companion SNAP musical sequence as it is played to the user, for example, via Bluetooth headset.

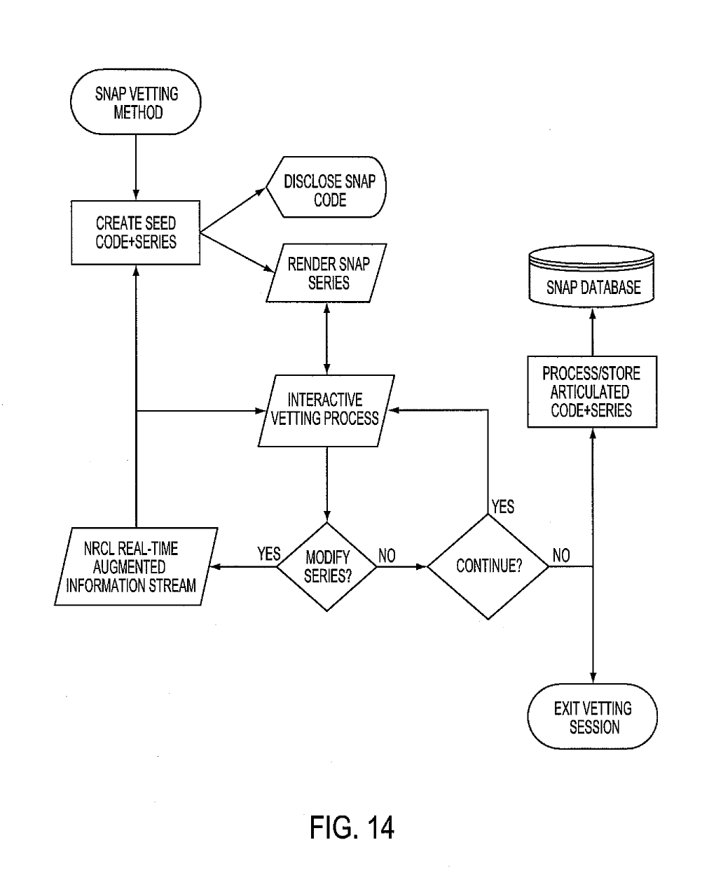

Outlining the details of this protocol, with each new symbolic code, the SNAP system simultaneously generates a companion non-symbolic tonal series that is unique. A different code/series is entrusted to each user requiring access to protected resources. They must subsequently complete the vetting process shown in FIG. 14 whereby each keystroke of the SNAP code is assigned, as facilitated by interactive algorithms, to a specific tone of the associated SNAP musical sequence. The user must then memorize the relationship between the specific tone and the associated keystroke, so that, when prompted by the tone, the appropriate keystroke is made to gain access to the desired resource. The Symbolic/Non-Symbolic Access Protocol is now fully articulated for that specific individual; it is like a “performance” that is first learned and then continually rehearsed every time it is executed.

Of critical importance, however, is the fact that though a symbolic representation of the musical sequence is stored in the SNAP system database, the user is never privy to it. Thus, as unusual as this security protocol may seem, the non-symbolic aspect of the SNAP method cannot be freely “given” away, lost, surrendered, or even sold outright by the vetted individual. In addition, cognitive processing of the dichotomous password, i.e., the SNAP code/series, is more elaborate than learning a simple string of characters and ostensibly yields a more robust security protocol with a minimum of system overhead and cost. SNAP represents an unquantifiable increase in the level of security provided while exhibiting a substantial reduction of escalating password complexity requirements designed to keep proprietary resources truly secure.

The SNAP method incorporates the NRCL bound data type that transcends security measures based on symbolic coding alone or solely biometric measures that quantify (digitize) non-symbolic physical attributes. Furthermore, the bound data type at the core of the SNAP system cannot be adequately simulated by deterministic processes such as Pseudo Random Number Generators (PRNG). In other words, the source of “chance” for the bound symbolic/non-symbolic data type is unitary, synchronous, indeterminate and tamper-proof.

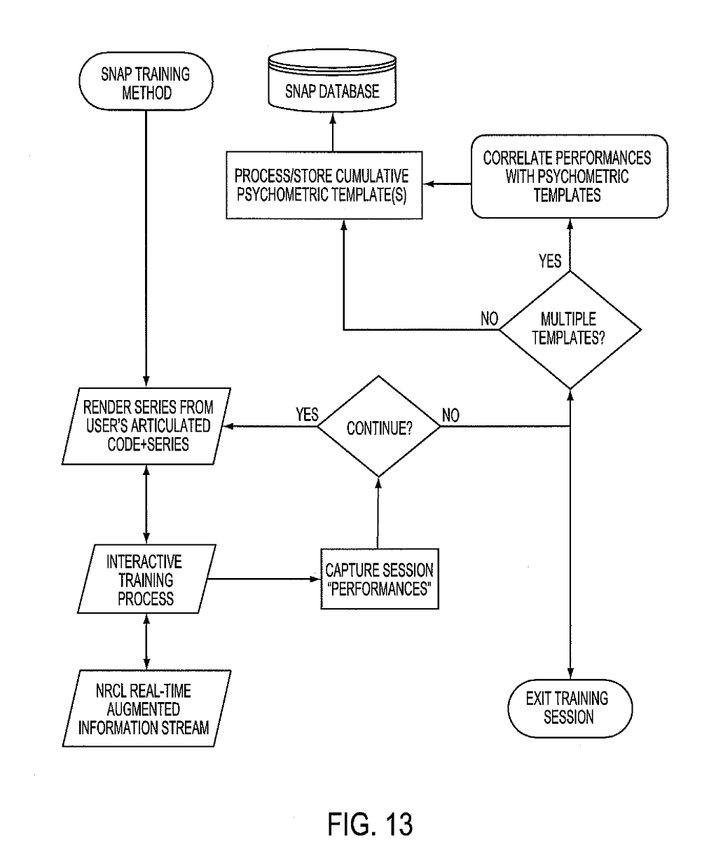

Additionally, cognitive aptitude, capacity, and processing of non-symbolic information exploits human abilities not normally associated with security techniques, whose importance is often overlooked and understated in such applications. Most significant, the SNAP method does not simply grant secure access but can also authenticate or “profile” an individual requesting access through psychometric, as opposed to biometric, analysis. As shown in FIG. 12, each user develops a unique psychometric profile over time, every time they use the SNAP method, and is as characteristic as a fingerprint that cannot be mimicked. In addition, for high security applications and environments, training sessions may be instituted as shown in FIG. 13 that could harvest multiple psychometric profiles, or templates, over a given user's set of definable mental states.

Symbolic information is the basis of standardized communication and there are inherent risks involved when security protocols rely on this information class. The nature of human interaction with modern day alphanumeric codes is based on the enduring cultural standards of Latin characters and Hindu-Arabic numbers. As such, it is very difficult to trace the source of a security breach when the conveyance of information is standardized over large populations and can so easily be transferred via email, text message, binary numbers, or even on a Post-It®. However, non-symbolic information, in and of itself, cannot be so easily transferred simply because there are no formal standards of conveyance over any given range of disciplines.

To underscore the nature of such standards, consider what it would be like to tell someone how long it takes to boil a pot of water without using symbols. In other words, for the information about the physical process to proliferate, we would normally use a symbolic conveyance like, “13 minutes and 47 seconds”, or “turning on the right-front burner under the blue pot filled with water at noon, it will start to boil at 12:19 PM”, or “if you have 500 grams of water at 20° C. and sea level pressure, and then add 13.376 kilojoules of energy to it every second, it will take 1000 seconds for the water to reach 100° C. and will begin to boil after exceeding the latent heat of fission”. It is virtually impossible to explain the amount of time it takes to boil water to any degree of accuracy without using symbolic references. Consequently, if a fully articulated SNAP code/series is compromised, it can easily be traced back to the source, the route of acquiescence readily exposed, and immediate measures taken to stem the security breach.

Known random number generators produce a running sequence of numbers typically synthesized from non-deterministic sources such as electronic noise. However, a random number or sequence by itself may not adequately represent the broad nature of complex behavior from which the number or sequence is derived. For example, electronic noise is characterized by a fluctuating voltage within an upper and lower voltage limit and a range of frequencies between an upper and lower frequency limit. Both of these parameters must be integrated into a system design to characterize the complexity of dynamic behavior from which the random numbers are created.

The default origin of the NRCL bound data type is its internal noise sources, also called its statistical entropy sources. The acoustic equivalent of this phenomenon is the sound we get when letting air out of a car tire and an actual noise signal from the NRCL prototype circuitry is shown in the upper waveform of FIG. 3.

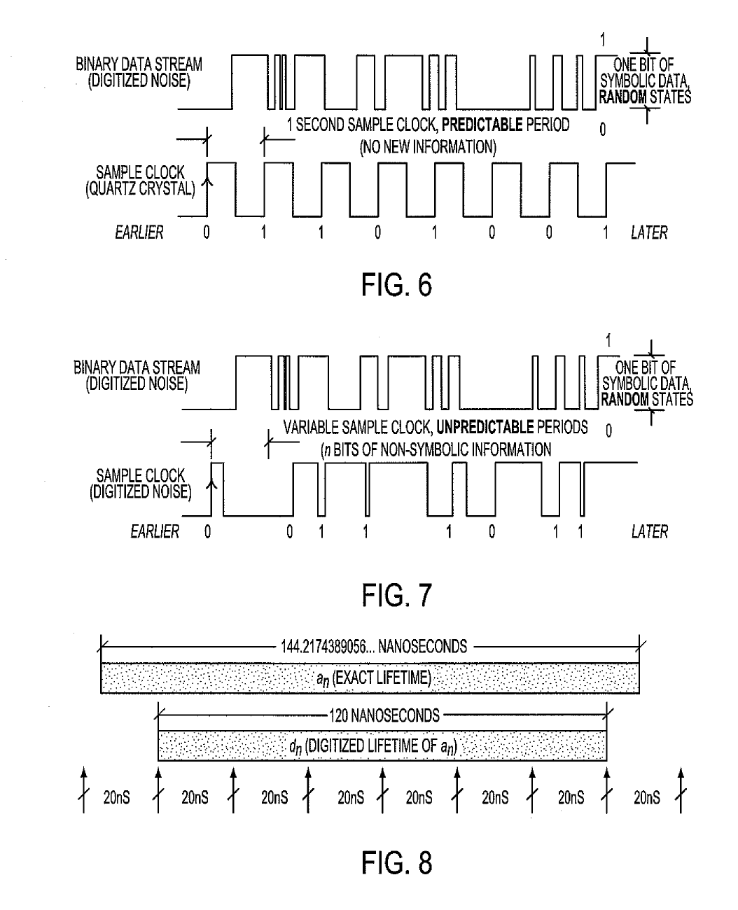

This analog noise is subsequently converted into a binary signal as shown in the lower waveform of FIG. 3. The resulting waveform has only two discrete voltage levels (states) and epitomizes one type of digitized noise. However, this signal can also be symbolically represented by a binary digit, or bit, since a bit has only two discrete values (states), i.e., zero (0) or one (1). At this point, a CLOCK would sample the digitized noise so that the device “knows” what state the DATA is in at any particular moment in time. We could use a periodic sample CLOCK as shown in FIG. 6, very much like a quartz kitchen clock, to “see” (sample) the DATA on every rising edge of the CLOCK, i.e., with every “tick” of our kitchen clock. The first rising sample CLOCK edge is highlighted in FIG. 6 and FIG. 7 with a rising arrow.

However, the design configuration described above is nothing more than a traditional True Random Number Generator (TRNG). There is, at most, only one bit needed to represent all the information available from the binary DATA stream over time and each bit in the sequence of acquired data is concatenated (sewn together) to synthesize codes or symbolic information at the output. The concatenated bit sequences are displayed below the CLOCK streams of FIG. 6 and FIG. 7.

In contrast, the NRCL device replaces the traditional sample CLOCK of FIG. 6 with digitized noise as shown in FIG. 7. The result is the inclusion of real-world (non-symbolic) information defined as quantified intervals of time. We no longer have a traditional TRNG but a machine that extracts a parameter of digitized noise not common to the TRNG design type.

A substantial amount of information is lost when we commit noise to a binary approximation of itself. However, the quantity of information lost between each rendering of data at the NRCL output is recovered by measuring the interim interval of accumulating NRCL clock periods. That is, we measure the amount of time that passes between each data output rendering by quantizing or symbolizing it. Time is, implicitly or explicitly, part of all physical attributes and considered a non-symbolic information archetype.

Thus, the binary DATA stream produces codes or symbolic information at the NRCL output. The duration or lifetime of each code, however, is represented by an uncountable number of symbolic data bits (shown as n bits in FIG. 7) in quantifying the interim summation of continuously variable, unpredictable sample CLOCK periods. Simply put, the NRCL lifetime data type presented at its output is commonly referred to as a digital period measurement, which is necessarily a symbolic paradigm of non-symbolic information. Alternative embodiments of the device transpose manifestations of non-symbolic information directly into a physical attribute while storing a symbolic representation, or quantization, of the attribute in a computer database.

We shall turn now to a description of the preferred embodiment of the method and apparatus for generating the Non Repeatable Code Lifetime.

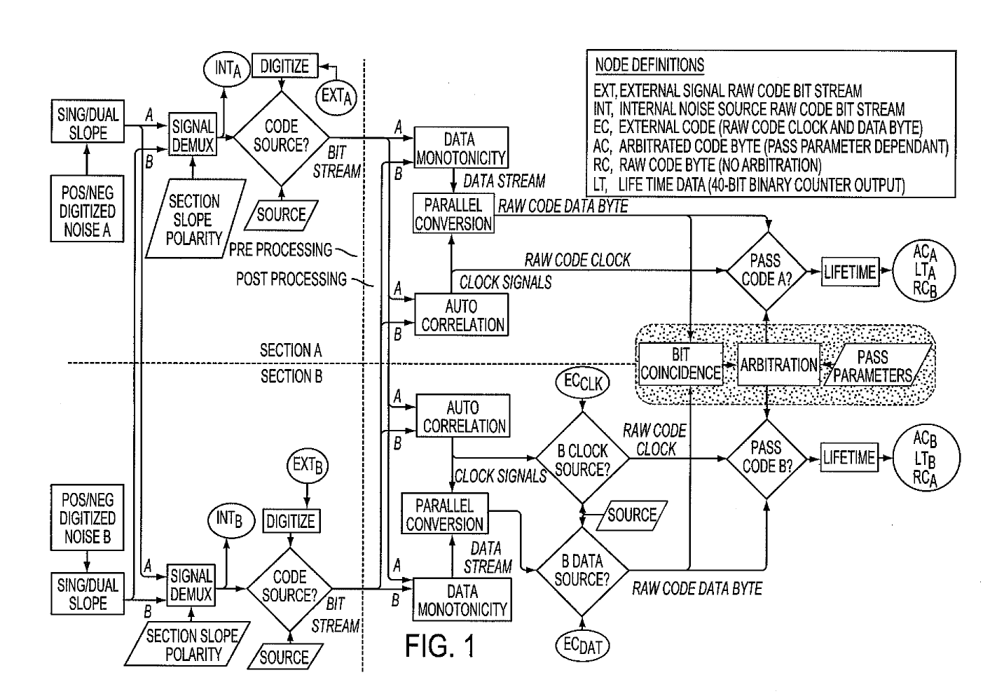

As shown in the Non Repeatable Code Lifetime generator block diagram of FIG. 1, there are two independent sections identified A and B, each of which generates a running sequence of raw code bytes. Each code that is accepted for final output from a given section has undergone a process of numerical arbitration according to a set of pass parameters. A raw code byte in one section is compared to the raw code byte that exists, at any particular moment in time, in the opposing section. If a section's arbitration clock signal occurs at the instant when the raw code byte under consideration complies with pass parameter criteria, the code is approved for final output and is then considered an arbitrated code byte. Section B may also accept external raw code bytes, clock signals, and the Coincidence Level (CL) parameter explained below via rear panel input.

A fundamental criterion of arbitration is based on the coincidence of equal bits in similar bit positions between the raw code byte of each section and is called Bit Coincidence (BC). BC has an integer value of zero (bitwise inverse) through eight (equal bytes). BC is tested against a preset Coincidence Level (CL) that is programmed via front panel or external control and has an integer value of zero through eight. As such, approval of a raw code byte for final output is contingent on the effective pass parameters BC=CL, BC≦CL, BC≧CL, and (BC≦CL OR BC≧CL) also named Free Run (FR) where the raw code byte of a given section is unconditionally passed to the final output as an arbitrated code byte. As such, the NRCL generator has the ability to produce digital codes at the output that “range” from completely random to fully deterministic with respect to the opposing section.

The lifetime of each arbitrated code byte is the amount of time the approved code is “waiting” to be sent to its final output register, which in turn is dependent on how long its successor takes to meet its pass parameter criteria. It can be thought of as an individual's lifetime. It is only complete, and can only be expressed, when the code, or individual, no longer exists in the present, i.e., when the code is “archived”. In other words, the lifetime data type is a primary characteristic of a predecessor code byte. Bound to each arbitrated code byte will always be its lifetime and, in the prototype, the raw code byte of the opposing section to be used for verification, validation and testing.

The collective aspects of non-deterministic amplitude and frequency components found in noise are characterized by the two NRCL data types, arbitrated code+lifetime, bound together through the dynamics of their common source. As such, the primary objective of NRCL information output is intervals of time and not machine states, underscoring the fact that the inventive method is not based on, or represented by, the defining principles of a True Random Number Generator. Utilizing the numerous NRCL system configurations, the arbitrated code outputs can range from completely random to wholly deterministic. However, the nature of lifetime in both sections A and B is always unpredictable and not simply random as explained below.

Even when NRCL symbolic information outputs are completely random, as when Free Run is enabled in both sections A and B, they are still deemed predictable with the following connotation. Each code byte in the prototype is a synthesized number whose range is expressly limited to 256 signed or unsigned integer values and we can predict, for example, that the occurrence probability of any value may be one in 256, i.e., the “fair dice” scenario. If the code outputs were truly unpredictable, however, then they could be any number including very large numbers. Yet this property more aptly defines the 40-bit lifetime data word rather than its companion arbitrated code byte. Every measured parameter of any natural system under observation is an incomplete quantization, regardless of whether analog or digital measurement techniques are used, involving many more levels of resolution than could ever be expressed. This is an ever-present limitation even in state-of-the-art Test & Measurement science and technology.

In other words, though lifetime is a quantized observation confined to a statistically predictable range of digital period measurements, the amount of information in-between consecutive unit intervals of a single digital period measurement is indeterminable. This amount of information is represented symbolically as a very large number that is characteristically unpredictable by virtue of measurement uncertainty. The arbitrated code bytes of sections A and B are expressly limited to a finite set of 256 possible values. However, the interval of time associated with each code is continuously variable, interminably resolved and always unpredictable. Thus, the nature of lifetime is that of very large, unpredictable numbers that figuratively belong to the “universe” of the in-between and not that of the very big or the very small.

The high-level correlation between randomness and unpredictability is made apparent in the inventive method, and subsequently in the SNAP design, when the relationship between BC and CL is computed, arbitrarily approved and the system generates the first, digital, component, of a security protocol, while the duration of that BC value ultimately generates the second, analog, component of the security protocol.

In the NRCL prototype implementation, each section's final output produces three data types simultaneously: the arbitrated code byte E, the lifetime data word Z of the arbitrated code byte, and the raw code byte F of the opposing section. Data type Z is a 40-bit binary number derived from a synchronous binary counter chain driven by a deterministic system clock called the lifetime clock. The least significant bit of z is the resolution of the lifetime interval which is also equal to the lifetime clock period and is designated Zres. The prototype lifetime clock runs at 50 MHz so Zres=(50×10⁶)⁻¹=20×10⁻⁹ second making the resolution of the 40-bit lifetime data word equal to 20 nanoseconds. The output data types are represented by the following notation:
1) xE[n], where E=Arbitrated Code byte, x=section identifier, and n=sequence index;
2) xF[n], where F=Raw Code byte, x=section identifier, and n=sequence index;
3) xZ [n], where Z=40-bit Lifetime data word, x=section identifier, and n=sequence index.

Variable x has only two possible values, section A or section B {a, b} and the sequence index n is an integer. For example, aE[23] is the arbitrated code byte from section A and the 24th member in a sequence that begins at aE[0]. The lifetime of aE[23] is aZ[23] and the raw code present in the opposing section at the time aE[23] was approved for final output is bF[23]. Lifetime is intrinsically bound to, or associated with, its arbitrated code byte and this relationship can be expressed as an augmented data type by merging two data notations thus, aEZ[23]. Additionally, the expression aE[k]ₖ₌₀⁵ defines a finite arbitrated code byte sequence from section A beginning at aE[0], ending at aE[5], and consisting of six sequential elements. Note that as used herein, the term “sequential element” is synonymous with “consecutive element”, i.e., one element after another.

Bit Coincidence BC begins with the bitwise XNOR of raw code bytes from each section. If, for example, aE[23]=10110010₂ and bF[23]=00110111₂ then the bitwise XNOR will yield an 8-bit data byte with a 1 in those positions where the code bytes have the same bit value, in this case 01111010₂. Through a series of half adders the number of 1's are counted to give BC=5. At this point BC is compared to CL and a set of magnitude parameters is generated. Free Run (FR) is the case where BC<CL or BC=CL or BC>CL effectively allowing all raw codes of a given section to be handed off for final output as arbitrated code bytes. Note that aE[23] was approved for final output because of the arbitration performed on it as a raw code byte according to internal NRCL system processes. As a matter of post output testing, however, it can be compared to bF[23] in order to verify NRCL system dynamic operation.

Each collective state of NRCL system vectors, applicably termed control parameters, is a member of the finite set cf of system configurations that could potentially affect output behavior. In the prototype, the individual state of each control parameter is accessed via the front panel manually or by external, rear panel input. As illustrated in FIG. 1 and outlined below, there are two basic categories of system vectors called the pre- and post-processing control parameters. Counting all possible combinations of control parameters gives a general idea of the effective number of system configurations that could influence dynamic behavior. From this, we derive a fixed-length encoding scheme required for external interface with other systems through a rear panel connector. Though the list below may not represent all possible system vectors, the NRCL prototype implementation of its control parameters is as follows:

A. Pre-Processing Control Parameters
1) SRC, raw bit code source, INT (internal) or EXT (external);
2) SEC, raw bit code section, section A or section B;
3) POL, raw bit code polarity, POS (positive) or NEG (negative);
4) SLOPE, raw bit code slope source, SING (single bit stream) or DUAL (differential bit stream);

B. Post-Processing Control Parameters

1) DM, Data Monotonicity, Enable or Disable;

2) AC, Auto Correlation, Enable or Disable;

3) FR, Free Run parameter, Enable or Disable;

4) PP, Pass Parameters, BC=CL (always active), BC>CL (BCCL), or BC<CL (BC≦CL);

5) CL, Coincidence Level, accepts 4-bit hexadecimal and converts it to 0 through 8.

The bracket notation {current choices|group product} is used to show the number of current choices with the control parameter under consideration and to keep track of the accumulated product of choices as the related control parameter group grows in number. We begin by counting the two {2|2} sections each of which have the following control parameter set: Source (SRC) is INT or EXT {2|4}, Section (SEC) is A or B {2|8}, Polarity (POL) is POS or NEG {2|16 }, and SLOPE is SING or DUAL {2|32}. Counting the two post-processing configurations that do not affect pass parameters settings, there are two sections (already counted) of which Data Monotonicity (DM) is either enabled or disabled {2|4} and Auto Correlation (AC) is either enabled or disabled {2|128}. This group of control parameters is unaffected by the collective Free Run (FR) control parameter settings (see below) and is the configuration subset cf_{fixed} with 128 members.

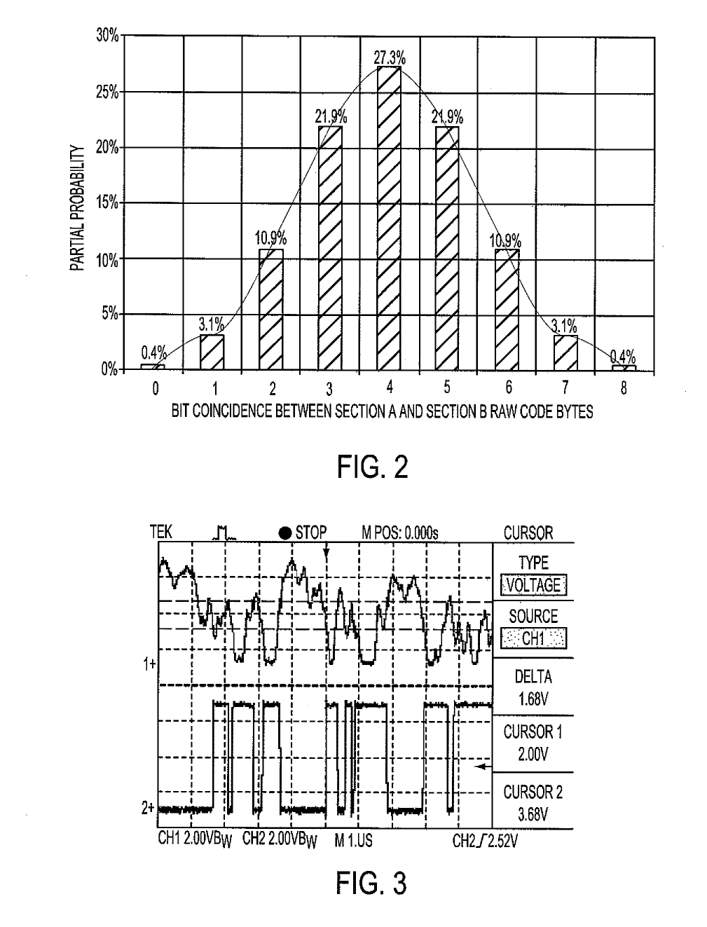

Pass Parameters BC=CL, BC≦CL (from (BC=CL)+(BC<CL)), and BC≧CL (from (BC=CL)+(BC>CL)) concurrently affect both sections A and B so there are only three 1313) possible control parameter states. Note that the prototype NRCL combinational logic gate implementation also allows the state (BC<CL)+(BC=CL)+(BC>CL) which is equivalent to Free Run (FR) in both sections and is logically expressed as FRa·FRb (see below). Coincidence Level state counting is derived from the fact that if the probability that a code bit is either 0 or 1 was exactly 0.5, then Bit Coincidence could be defined by a normal binomial probability distribution (FIG. 2). For this special case, it would only be necessary to consider five CL control parameter states, i.e., 0≦CL≦4 or 4≦CL≦8. Since it is rarely the case that there is an equal probability that a code bit is either 0 or 1, all Coincidence Levels must be considered unique giving a total of nine {9|27} possible CL states. This group of control parameters is the configuration subset cfₚₚ with 27 members.

We denote the post processing control parameter Free Run (FR) for each section as FRa and FRb because of its effect on cfₚₚ. It is only if FRa and FRb are disabled or only one is enabled that cfₚₚ is counted so there are only three {3|81} states of FR in both sections that allow cfₚₚ to be counted and comprise the configuration subset cf _{F̅R̅a̅·̅F̅R̅b̅}=cgₚₚ×3 with 81 members. This leaves only one {1|1} possible configuration when FR is enabled in both sections, FRa·FRb, that excludes cfₚₚ and is the configuration subset cf_{FRa·FRb} with only one member. Thus, the total members of the system configuration set are counted as cf=(cf_{fixed}×cf _{F̅R̅a̅·̅F̅R̅b̅})+(cf_{fixed}×cf_{FRa·FRb})=(128×81)+(128×1)=10496.

Note that the dynamic system configuration set counted in cf is implemented by a fixed number of control/data bits in a dedicated encoding scheme that is counted here. The bracket notation (current bit count|group sum) shows the control/input bit count under consideration and keeps track of the accumulated bit sum in the fixed-length encoding scheme. Two sections of seven bistable parameters require 14 control bits (14|14). Two bistable pass parameters BC>CL and BC<CL require two control bits (2|16). Coincidence Level accepts a 4-bit hexadecimal with a latching clock bit giving five control/input bits (5|21). A control bit determines the section B raw code byte and clock vector (1|22) along with inputs for an 8-bit raw code byte (8|30) and one raw code clock signal (1|31). Finally, a control bit (1|32) determines the vector between front and rear-panel configuration settings. Hence, the encoding scheme for external computer control comprises 32 control/input bits.

The principal supposition in assessing NRCL dynamic behavior is that both sections A and B utilize only the internal noise sources. The fundamental question is how the output of each section behaves based on the subtleties of the analog noise sources and the subsequent methodology of digital signal processing. Every effective NRCL system configuration needs to be carefully considered as each may potentially yield different statistical outcomes.

A set of statistical parameters, collectively called the statistical profile, is essential in characterizing the behavior of the arbitrated code and lifetime data outputs independently. This will give a baseline reference as to the fundamental nature of dynamic behavior each data type exhibits. In addition, it is recommended that a statistical profile of baseline behavior be devised to typify the augmented data type, xEZ[n]. It is expected that with increasing observations, the output progression of data given a fixed system configuration resembles a stochastic process. However, the invention is not confined to a fixed system configuration and its ability to accept external raw code bytes and clock signals through section B, along with an externally programmable Coincidence Level, lends itself to a changeable feedback loop that can dynamically alter the statistical profile in unforeseen ways.

There are three categories of recurrence that can be articulated by a simple mathematical expression with the following substitutions:

1) Sequence Element=Arbitrated Code, 5=E;

2) Sequence Element=Lifetime, S=Z;

3) Sequence Element=Arbitrated Code+Lifetime, S=EZ.

Given xS[0] is a sequence element and x=a or b, then the recurrence probability is defined as the average value of n where xS[0]=xS[n]. In other words, for a given sequence element and quantization error described below, how long will it take, on average, until the same element comes up again?

The general case of two or more sequence elements that are repeated again at some future time is xS[k]ₖ^{m}=0=xS[n+k]ₖ₌₀^{m} where k,m,n are integers and n>m>0. It is expected that with increasing values of m the recurrence probability decreases so that the average value of n increases.

One of the original design goals of the invention was to digitize the analog noise sources without the need for any adjustment procedure. However, it was preferred to achieve a dynamic balance between the arbitrated code outputs, i.e., the machine state outputs, and the lifetime data word that is essentially a digital period measurement. To achieve this objective, the invention includes adjustment potentiometers for overall optimization of the digitized noise bit stream to accommodate the best possible rendering of all output data types.

NRCL internal noise sources are digitized by passing them through Schmitt Trigger inverters (74HC14). This process is described as the binary quantization of an analog noise signal whose output is manifest as a single bit stream as shown in the lower waveform of FIG. 3. There are two reasons for this step. First, the signal should be converted from an analog format into one of several possible digital protocols for subsequent processing. In the case of NRCL implementation, this renders a binary pulse train that can assume only one of two possible states at any particular moment in time, a zero state (0) when it is at zero volt potential and a one state (1) when it is at the power supply potential.

Second, the amount of information contained in the signal generated by a reverse biased avalanche noise diode is inestimable and not well defined. If this data is modeled in terms of set theory, the total information content produced by a noise source may be described as all those attributes of the phenomenon that can be measured, or quantified, yielding set M of uncountable, incongruous members over time. Binary quantization of the analog noise signal renders a manageable, well-defined subset M¹ of this information such that M¹⊂M. Each member of M¹ is an ordered pair consisting of the output state, either zero or one, and its dwell time, i.e., how long it remains stable before changing to the opposite state. Hence, a sequence of subset members, or elements, over time has a deterministic progression of alternating states each of which is paired to a non-deterministic, continuously variable dwell time.

There is a substantial loss of information in committing to this quantization protocol with regard to the set M of total information content of the original noise signal. However, the binary quantization process that yields subset M¹ can be optimized so that information loss is minimized. Information about the source signal is only known exactly when it traverses the hysteresis window, also called the quantization aperture, and appears as either a positive or a negative edge of the bit stream constituting the actual raw code clock signals. A stable state, whether 0 or 1, has a corresponding dwell time that tells us how long the noise signal remains on one side of the active hysteresis transition level and constitutes the actual raw code data. The quantity of information loss, denoted I_{LOSS}, is related to the dwell time t in seconds. In other words, we can never know what information was lost, only how much potential information could have been retrieved based on dwell time and system bandwidth. Quantity of information loss per state is unpredictable, continuously variable and comprises the fundamental building block of arbitrated code lifetime, i.e., the summation of alternating state dwell times.

The NRCL digitized noise output of each section is essentially an electronic coin toss represented by the random Boolean variable X that has only two possible values and codifies the nature of information retrieval. If we assign a 1 state (HEADS or TRUE) to X, then by default X̅ is 0 (TAILS or FALSE). On the other hand, if we assign a 0 state to X, then X̅ is a 1 state. The probability P_{X} that state X will occur is calculated from n like-state dwell times over 2n consecutive observations as shown in equation 1. Conversely, P _{X̅} is the probability that state will not occur, i.e., that state X̅ will occur as calculated in equation 2. The quantity of information retrieved from the binary quantization of analog noise, denoted I_{GAIN}, depends on the calibration of noise gain and offset, and the statistical entropy characteristics over time of the noise source itself. An analytical metric of I_{GAIN} is information entropy which, within the scope of the invention, is simply defined as the amount of information retrieved from a statistical entropy source, usually the internal avalanche noise diodes, and is expressed as f(I_{GAIN}).

As the information entropy f(I_{GAIN}) of the NRCL raw noise bit stream approaches one (1), then the probability of encountering a 0 or 1 state at any given moment approaches 50 percent. However, depending on the quantization aperture, the avalanche dynamics of the noise diode, and the information density of the statistical entropy class captured through binary quantization, it may be that information entropy of the raw noise bit stream may never even come close to one. Regardless of this fact, we can still define a generalized inverse relationship between information gained and information lost such that as one increases, the other decreases, expressed as I_{GAIN} R⁻¹I_{LOSS} and specifically define a function of the quantity of information loss as the inverse of information entropy written f(I_{GAIN})=f⁻¹(I_{LOSS}). Based on these observations and assertions, the NRCL binary quantization process is comprehensively assessed in terms of the binary entropy function of a Bernoulli trial H_{b}(P_{X}) related to I_{GAIN} as f(I_{GAIN})=H_{b}(P_{X}) (equation 3) and is considered optimized when H_{b} reaches a maximum, or when f(I_{LOSS}) reaches a minimum.

Of crucial significance is that the “unpredictability” of NRCL digitized noise be as great as possible so that, ultimately, the first-stage raw digital data codes comprising the unprocessed symbolic information data types are maximally random. As such, the basic metric of unpredictability in the NRCL binary quantization process is calculated from digitized signal non-linearity and begins with the average absolute value of normalized dwell time differences, shown in equation 5, between n+1 consecutive, overlapping states. This is defined as the normalized Disparity mean μ_{D} between the quantities of information loss on either side of the hysteresis window over time and is calculated as shown in equation 6. From this, the normalized Disparity standard deviation σ_{D}, simply called Disparity deviation, is calculated in equation 7 and reflects the degree of non-linearity in the input signal that appears at the output waveform of binary quantization. Equation 4 shows absolute value dwell time differences and how they overlap. Note that if the input noise signal was replaced by a sine wave, for example, there would be no appreciable variation in the output dwell time differences of alternating states and Disparity deviation would approach zero (σ_{D}→0) indicating complete predictability in a digitized sine wave signal.

$$\begin{matrix}{P}_{x} = {\sum }_{k = 1}^{n} {f}_{2 , k} \text{/} {\sum }_{k = 1}^{n} ( {t}_{2 k} + {t}_{2 k - 1} ) . & equation 1 \\ {P}_{\overline{x}} = ( 1 - {P}_{x} ) = {\sum }_{k = 1}^{n} {t}_{2 k - 1} \text{/} {\sum }_{k = 1}^{n} ( {t}_{2 k} + {t}_{2 k - 1} ) . & equation 2 \\ {H}_{b} ( {P}_{x} ) = - [ ( {P}_{x} {log}_{2} {P}_{x} ) + ( {P}_{\overline{x}} {log}_{2} {P}_{\overline{x}} ) ] . & equation 3 \\ {d}_{1} = \vert {t}_{1} - {t}_{0} \vert {\to }^{time} {d}_{2} = \vert {t}_{2} - {t}_{1} \vert . & equation 4 \\ {D}_{k} = ( {d}_{k} - {d}_{min} ) \text{/} ( {d}_{max} - {d}_{min} ) . & equation 5 \\ {μ}_{D} = \frac{1}{n} {\sum }_{k = 1}^{n} {D}_{k} . & equation 6 \\ {σ}_{D} = \sqrt{\frac{1}{n} {\sum }_{k = 1}^{n} {( {D}_{k} - {μ}_{D} )}^{2}} . & equation 7\end{matrix}$$

Where t=dwell time in seconds; n=number of observations; k,n are integers and n>1; P_{X}=probability that X occurs; P _{X̅}=probability that X does not occur; H_{b}=binary entropy function; d=raw dwell time Disparity of adjacent states; D=normalized Disparity of Information Loss; μ_{S}=normalized Disparity mean; and σ_{D}=normalized Disparity standard deviation.

The essence of non-repeatable lifetime is based on the assumption that the digitized noise bit stream driving the outputs is eminently chaotic. However, a complex analysis to determine whether the NRCL noise sources are chaotic may not be necessary since, at a most fundamental level, no two intervals of time are identical and are, hence, non-repeatable. As such, Disparity deviation essentially quantifies, in simple manner, the “uniqueness” of NRCL statistical entropy sources, is the chosen measure of unpredictability for the NRCL lifetime data type, and σ_{D} is the metric that characterizes the “selectability” of information through a single-stage binary quantization process.

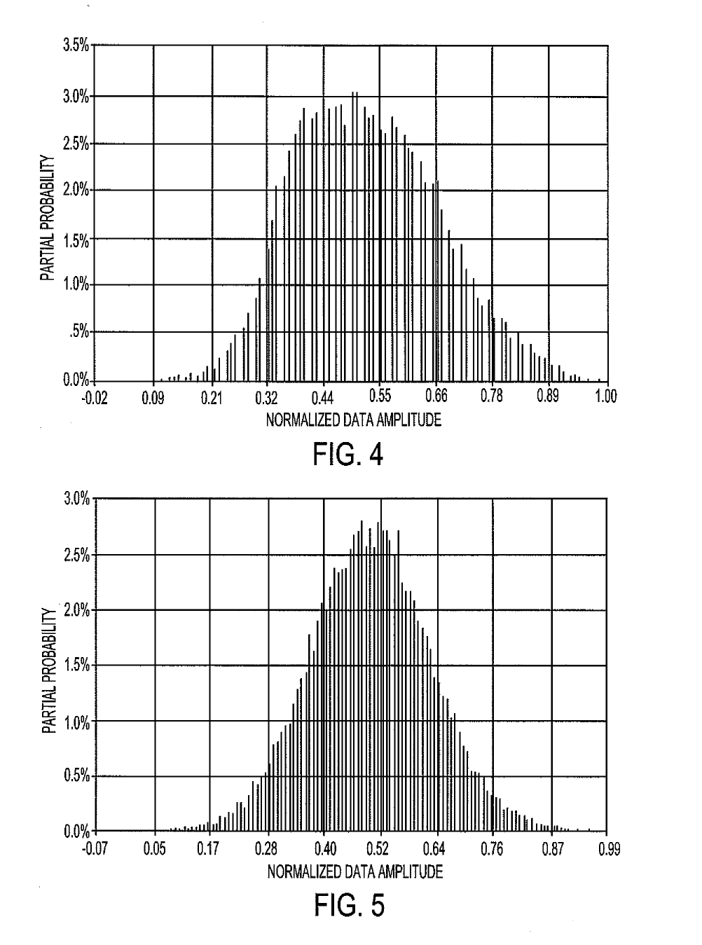

The NRCL avalanche diodes generate Gaussian noise that can also be computer-generated utilizing a set of deterministic equations in known fashion and presented at the input of the NRCL Schmitt trigger inverters. Typical amplitude data distribution of real and synthesized Gaussian noise sources are shown in FIG. 4 and FIG. 5 respectively. The fact that this signal can be produced by deterministic means is one indication that Gaussian noise is, to some degree, chaotic. However, the advantage of using avalanche diodes is their “portability” in that they require absolutely no computer resources to generate their analog noise signal. They are physically compact, have a very simple hardware implementation, are well suited for real-time information streaming, and offer many orders of magnitude in economy of system resources.

The most significant difference between real noise and computer-generated noise is the fact that the former is mathematically represented by a continuous function (hence the term “analog” noise) and the latter by a discrete function. Real noise is not governed by any deterministic function of time, such as a system clock, and its dynamic behavior is commensurate with the NRCL realization of the lifetime data type in that xZ[n] is continuously variable. In addition, output data produced from statistical entropy sources is untraceable. In such configurations, NRCL implementation as a stand-alone system, or component sub-system, can be characterized as a “black box”.

Electronic noise is fundamentally a random process that is comprehensively defined in terms of its spectral frequency content as observed in the amplitude-frequency domain. However, the NRCL binary quantization process functions in the amplitude-time domain of the analog noise sources. As such, the larger amplitude components of noise are linked to the lower frequency components and the smaller amplitude components are linked to the higher frequency components. Each distinguishable frequency component exhibits complex, non-linear dynamic behavior. However, the larger the noise gain, the greater the summation of components processed by binary quantization given H_{b}→1 and the digitized noise exhibits stochastic behavior.

Slowing down the digitized bit stream by attenuating the input gain effectively excludes higher frequency components of the noise signal resulting in the increasing isolation of the single largest amplitude-lowest frequency component. The characteristic dynamics of each contributing frequency in a Gaussian noise source become more apparent as we isolate a single frequency component for examination. This assertion is based on preliminary observations of digitized noise showing that as noise gain decreases, information retrieved from binary quantization exhibits increased variability as reflected in σ_{D} suggesting a greater degree of randomness attained in the raw data code outputs. It is proposed that this trend is more indicative of the complex, non-linear dynamics that make up a single frequency component of the avalanche noise source rather than the cumulative harmonic content of a mixed signal component from the same source.

In addition, for those NRCL system configurations that pass the digitized noise bit stream through binary rate multipliers, preliminary observations show a binary rate multiplier effect that appears to increase the statistical variability of digitized noise, as σ_{D} would indicate. It is proposed that the shorter dwell times that typify higher frequency components of Gaussian noise are uniformly distributed throughout the binary quantization bit stream and their “assimilation”, even only after a few stages of binary division, appreciably isolates the single largest amplitude—lowest frequency component of Gaussian noise through temporal, as opposed to amplitude, filtering.

Uncertainty exists, to a greater or lesser extent, in all naturally occurring (physical) systems. Two fundamental classes of uncertainty in the NRCL generator are independent of each other and play significantly different roles in the behavior of the final output data types.

Though the NRCL system is not, in principle, a simple random number generator, it is critical that the first-stage, unprocessed raw data codes from each section, as synthesized from the internal analog noise sources, be as random as possible. This is the case where design objectives require maximum uncertainty and are predominantly realized through the manipulation of information entropy H_{b} as described. In other words, the long-term probability that any bit of any code byte is either 0 or 1 should ideally be 50 percent. Since this may not be attainable in the digitizing process, the raw noise bit stream may optionally be passed through at least one internal binary rate multiplier before any post-processing. In this way, the statistical profile and recurrence probability will be unaffected due to inherent bias of the digitized noise bit stream toward 0 or 1. Even so, it is necessary to consider nine possible states of Coincidence Level, as opposed to five, when counting the total number of possible NRCL system configurations since the average value between 0 and 1 states will never be exactly 0.5 under the best of conditions and over any sample interval.

The majority of the circuit implementation responsible for generating raw data codes is structured around the maximization of code bit uncertainty by the optimization of binary quantization. NRCL calibration methodology dictates that the avalanche noise entropy class selected for binary quantization be “isolated” and “moved”, via differential amplifier gain and offset respectively, as close to the Schmitt Trigger hysteresis midpoint as possible. Ideally, this maximizes information entropy, or H_{b}, and represents the greatest amount of information that a single-stage binary quantization process can possibly retrieve from an explicit class of statistical entropy within the avalanche noise signal. From this, one flip-flop divider stage can ensure bit parity for statistical randomness in the pre-processing circuitry if so desired. Final raw code synthesis is optionally processed through Auto Correlation and Data Monotonicity circuitry allowing for relative rate mismatches between clock and data bit stream signals.

If Auto Correlation is enabled then the data bit stream is sampled only after it has changed state at least once. This feature avoids the acquisition of redundant data, i.e., data that has not changed from its initial sampling and occurs if the sample clock runs faster than the data stream. Auto Correlation is a design feature that has been used in many previous applications of the art. Data Monotonicity, on the other hand, is unique to the inventive method and generally new to digital electronic design techniques because the sample clock is also a digitized noise bit stream. If, for example, Auto Correlation is enabled and the data stream runs much slower than the sample clock, then the resulting raw code byte will be an alternating series of zeroes and ones. Data Monotonicity allows the data stream to acquire the instantaneous clock state effectively exchanging the logic definitions of “clock” and “data”. The acquired bit constitutes one input of an Exclusive OR (XOR) gate with the data stream itself as the second input and forms a controllable inverter circuit block.

Measurement uncertainty is an unavoidable aspect of quantifying any physical attribute and has been the topic of countless white papers in the science of Metrology. The prototype NRCL lifetime data type has a resolution of 20 nanoseconds, specified as Zres=20×10⁻⁹ second. As such, even under the best possible conditions of measurement accuracy and precision, the uncertainty imposed by measurement resolution alone will always result in the NRCL's, and in fact any Test & Measurement system's, inability to represent the exact analog lifetime aₙ, for any n, of the arbitrated code byte due to quantization rounding. In particular, the digitized lifetime measurement dₙ of aₙ can be “off” by up to, but never reaching, 40 nanoseconds or 2×Zres as illustrated in FIG. 8 and specified as dₙ<aₙ<(dₙ+(2×Zres)), irrespective of measurement accuracy and precision.

In general, measurement uncertainty addresses the inherent limitations of digital period measurements that are more broadly bound by, but not limited to, time base stability (drift), output resolution (granularity), precision (repeatability), and accuracy (correctness) without going into a detailed discussion of these topics, as they are well understood by those of ordinary skill in the art. It is important to note that the NRCL lifetime data type is only ever limited, in general, by what the current state-of-the-art is in Test & Measurement science and technology.

Quantization error q_{E} due to granularity is singled out as the primary source of uncertainty in the arbitrated code lifetime data type. Justification for this assertion is based on the fact that lifetime is a characteristically descriptive parameter in the prototype and unrelated to substantive metrological standards, as is the case in a traceable time interval measurement of significant precision, so the relationship between xZ[n] and Zres is a minimized instance of measurement uncertainty. As such, the computation of q_{E} is expressed simply as q_{E}=(number of Zres periods)⁻¹. It follows that if the average arbitrated code lifetime, for example, is close to Zres as typified in FIG. 8, then the recurrence probability of xZ[n] will be high and not well defined with respect to statistical trends. This is a reflection of measurement uncertainty and not representative of the lifetime data type's true dynamic behavior.

Suppose, for example, that xZ[n]=000005C92A₁₆ for a given n, then q_{E}=2.6372838×10⁻⁶. If, on the other hand, xZ[n]=7DF39B005A6₁₆ for a given n, then q_{E}=1.6485726×10⁻¹². This is an error decrease of over six orders of magnitude. It is apparent that in order to reduce quantization error, it is necessary to slow down the digitized noise bit stream transition rate and exploit as much of the 40-bit lifetime data word capacity as possible. The simplest way to minimize lifetime measurement uncertainty for all NRCL system configurations is by the adjustment of differential analog noise gain and offset.

In the case of a sequence of bound data types, both classes of uncertainty in the NRCL design must be taken into consideration. The augmented symbolic/non-symbolic information class typified by the bound data type xEZ[n] concisely defines NRCL design objectives and is perhaps the most significant aspect of the Non Repeatable Code Lifetime generator. It is the encapsulation of coincidence, synchronicity, uncertainty and determinism found in all real world phenomena as part of any naturally occurring system.

Once a Bit Coincidence (BC) level and duration for that level is established, a bound data type is generated whose digital (symbolic) component ranges from completely random to fully deterministic, and an analog (non-symbolic) component that is always unpredictable. Based on this augmented information class, the Symbolic/Non-symbolic Access Protocol is a self-similar realization of the Non Repeatable Code Lifetime inventive method. SNAP compromises a novel type of proprietary access in its dichotomous password that is virtually impossible to transfer without teaching and practice.

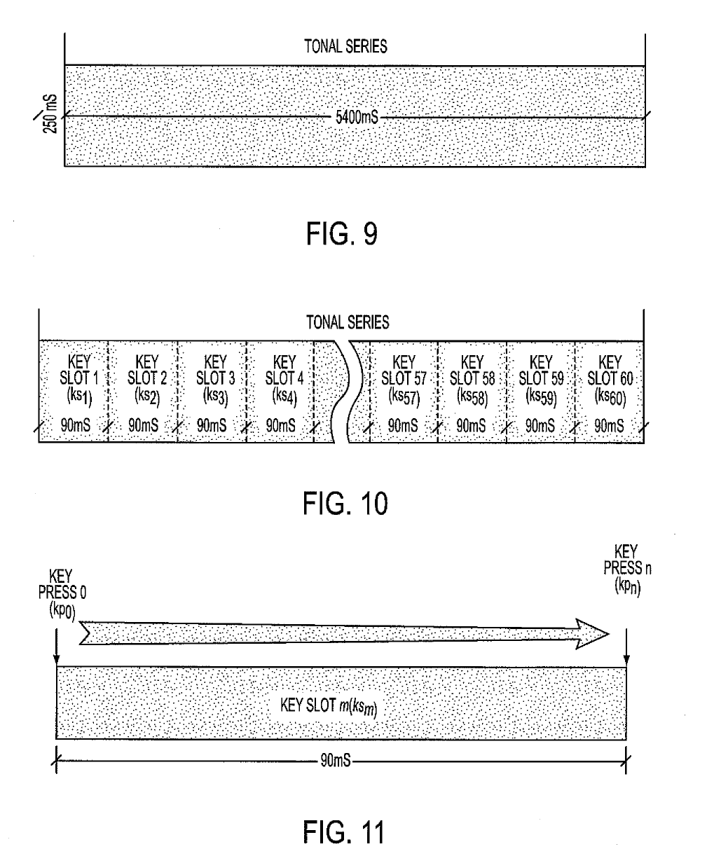

Assessing the strength of the SNAP method is based on the following discrete mathematical model of a specified implementation designed to accept motor nerve actuation on, for example, an access point keypad in response to auditory stimuli. The symbolic component is manifest as a 5-digit number or PIN and its companion non-symbolic counterpart is standardized to a 5.4 second (5400 mS) tonal series interval preceded by a 250 mS lead-in as shown in FIG. 9. The tonal series is subsequently parsed into sixty, 90 mS key slots as shown in FIG. 10. Each key slot is characterized as an “actuation window” where a user could potentially press a key while listening to the SNAP musical sequence. Five key presses are assigned to five different key slots within the tonal series during the SNAP vetting method shown in FIG. 14. As a statistical reference, we establish the probability of someone guessing a traditional 5-digit PIN by itself as one in 100 thousand (1:10⁵).

From this, evaluating the strength of the SNAP dichotomous password begins by counting all possible key press combinations, also defined here as states, and is calculated as the combination of 60 key slots assigned five at a time, written C(60,5)=5.461512×10⁶. However, all states that would contain adjacent key presses, as assigned by the vetting process to their corresponding key slots, must be disallowed to accommodate motor nerve response time over a large group of candidate users, i.e., the minimum time it takes an average person to press two or more keys in rapid succession. Since finding the exact number of states with adjacent key slot assignments is a difficult task, an approximate number was derived using a simple combinatorics counting method. First, the default 2-key adjacency present in the counting of all disallowed states is removed from the 5400 mS interval and the remaining 58 key slots are assigned three at time giving C(58,3)=30.856×10³ possible combinations. Next, with the default adjacency potentially occupying 59 different positions, the 60 key-slot tonal series is reconstructed and the approximate number of disallowed states is calculated as (30.856×10³)×59=1.820504×10⁶.

It is important to note that though there are counting redundancies in this combinatorics model, there are no omissions. Furthermore, in addition to all default 2-key adjacencies, this model includes all possible three, four, and 5-key adjacencies and all combination of adjacencies thereof. Thus, the number of valid key slot assignment combinations is conservatively estimated to be (5.461512−1.820504)×10⁶=3.641008×10⁶. From this, the strength of the SNAP security method is calculated as (1:10⁵×(3.641008×10⁶))=(1:364.1008×10⁹) or about one chance in over 300 billion at someone simply guessing a fully articulated Symbolic/Non-symbolic Access Protocol that uses a five-digit PIN linked to a five and a half second “melody”.

However, each key slot itself is a continuous time interval as shown in FIG. 11. Thus, the possible variations of an articulated SNAP code/series method could be much greater. In other words, the size of n in kpₙ (FIG. 11) that would still allow sufficient differentiation in spot psychometric assessments could be significant enough as to appreciably improve the strength of the Symbolic/Non-symbolic Access Protocol. There are further possibilities for even more secure protocols. Consider that the tonal series itself does not have to be based on a well-tempered scale. It could be based on a microtonal scale or even non-tonal related auditory stimuli that could invariably enhance the security profile of the SNAP method.

As discussed, other possibilities for combinations of analog and digital components of a password can be implemented, such as: a specific numerical sequence, where each number is input for a different length of time; a prompt-response password, where the password varies and the successful response requires the user to identify which number corresponds to a specific input stimulus, which could be by sight, sound (described in the SNAP method), or even tactile sensory input. In each of these cases, the security protocol is difficult to transfer to another because it requires a subtle learning process that does not lend itself to a simple passing along. Similarly, the protocol is not easily “hacked” or inferred, because it is not generated or archived by the user, as in the case of a password that can be written down.

The authorized user may be instructed on the proper security protocol in any suitable way, depending upon the particular combination of analog and digital components. For example, a tone generator may be coupled to an audio output (with headphones for added security) to generate a tone which must be paired with an input keystroke. Alternatively, the “teaching” device may include a keypad with lights that illuminate the key required to be entered, and a secondary light may go on to indicate the duration the key must be pressed.

Regardless, there must be some medium, such as a computer hard drive, which can store the associated digital and analog components of the input protocol, or password, as well as, preferably, the identity of the user authorized to use each specific protocol.

Furthermore, as is common in any system that relies upon human input, the inventive system must include some tolerances for responses, since a digital system, such as a computer hard drive, cannot fully reproduce an analog input, such as a duration of infinitely varying extent, as discussed above.

The system could also provide for use of a “panic” word, sequence or action input, so that, if the authorized user is operating under duress, he or she may undetectably signal that the password being inputted is done so under duress, so that security personnel may respond.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for generating a code, the method comprising the steps of:
generating an analog portion of the code;
generating a digital portion of the code; and
associating said analog and digital portions of the code;
whereby at least one of said analog and digital portions of the code is generated randomly.

2. The method of claim 1, wherein said analog portion of the code includes a temporal component.

3. The method of claim 1, wherein said analog portion includes a continuously variable physical attribute.

4. The method of claim 2, wherein said digital portion of the code includes requiring an entry from an input device having discrete inputs.

5. The method of claim 4, wherein said temporal component includes a duration for each of said discrete inputs.

6. The method of claim 5, wherein said discrete inputs are correlated to sensory stimuli, and the combination of said analog portion and said digital portion together comprises a sensory event.

7. The method of claim 1, wherein said analog portion of the code is non-representational.

8. The method of claim 1, wherein said generating of at least one of said analog and digital portions of the code includes deriving said at least one of said analog and digital portions of the code from a naturally occurring event.

9. A method for securing a location by use of a code, comprising the steps of:
generating an analog portion of the code;
generating a digital portion of the code;
associating said analog and digital portions of the code; and
training a user to respond to one of said analog and digital portions of the code by inputting the other of said analog and digital portions of the code to an input device;
whereby at least one of said analog and digital portions of the code is generated randomly; and
whereby said inputting of said other of said analog and digital portions of the code to said input device provides access to the location.

10. The method of claim 9, wherein said one of said analog and digital portions of the code varies, thereby varying the input of the other of said analog and digital portions of the code required to receive access to the location.

11. The method of claim 9, wherein said analog portion of the code include a temporal component.

12. The method of claim 9, wherein said analog portion includes a continuously variable physical attribute.

13. The method of claim 11, wherein said step of training includes entering the digital portion of the code using one or more discrete inputs.

14. The method of claim 13, wherein said temporal component includes a duration for each of said discrete inputs.

15. The method of claim 14, wherein said discrete inputs are correlated to sensory stimuli, and the combination of said analog portion and said digital portion together comprises a sensory event.

16. The method of claim 9, wherein said analog portion of the code is non-representational.

17. The method of claim 9, further comprising the step of training a user to learn a duress code, whereby the user may input the duress code to the input device to signal that the user is operating under duress, and thereby actuate a security system.

18. Apparatus for generating a code, the apparatus comprising:
an analog generator for generating an analog portion of the code;
a digital generator for generating a digital portion of the code;
a memory for storing an association between said analog and digital portions of the code;
whereby at least one of said analog and said digital generators generates its portion of the code randomly.

19. The apparatus of claim 18, further comprising a third generator for generating a duress code, and said memory also stores said duress code in association with said analog and digital portions of the code.

20. The apparatus of claim 18, wherein at least one of said analog and digital generators generates its portion of the code based upon a naturally occurring event.

21. The apparatus of claim 20, wherein at least one of the analog and digital portions of the code includes a temporal component.

22. The apparatus of claim 21, wherein said digital portion of the code includes musical notes, and the combination of said analog portion and said digital portion together comprises a musical sequence.
